(19) United States
(12) Patent Application Publication
(10) Pub. No.: US 2008/0278311 A1
(43) Pub. Date: Nov. 13, 2008

(54) Advanced Emergency Geographical Information System

(75) Inventors: Jeff T. Grange, Yucaipa, CA (US); Stephen W. Corbett, Lake Arrowhead, CA (US)

Correspondence Address: SHELDON MAK ROSE & ANDERSON PC, 100 Corson Street, Third Floor, PASADENA, CA, 91103-3842, US

(73) Assignee: LOMA LINDA UNIVERSITY MEDICAL CENTER, Loma Linda, CA (US)

(21) Appl. No.: 12/067,600

(22) PCT Filed: Aug. 10, 2007
(86) PCT No.: PCT/US2007/075751

§ 371 Date: Mar. 20, 2008

Related U.S. Application Data
(60) Provisional application No. 60/822,054, filed on Aug. 10, 2006.

(51) Int. Cl. G08B 19/00

(52) U.S. Cl. 340/539.2

(57) ABSTRACT

A geographical information system (“GIS”) for integrating multiple spatial emergency data, multiple non-spatial emergency data or both multiple spatial emergency data and multiple non-spatial emergency data into a real-time GIS for analyzing emergency data. A method for integrating multiple spatial emergency data, multiple non-spatial emergency data or both multiple spatial emergency data and multiple non-spatial emergency data into a real-time GIS for analyzing emergency data.

### CROSS-REFERENCE TO RELATED APPLICATION

The present Application claims the benefit of U.S. Provisional Patent Application No. 60/822,054, filed Aug. 10, 2006, entitled “Advanced Emergency Geographic Information System,” the contents of which are incorporated herein by reference in their entirety.

### FIELD

The invention pertains to the field of geographical information systems and more specifically to an advanced emergency geographical information system for integrating multiple spatial and non-spatial emergency data into a real-time, easy to understand display for consumer, commercial and military use.

### BACKGROUND

A geographical information system (“GIS”) is used for creating, storing, analyzing and managing spatial data and associated attributes, and displaying geographically-referenced information. There are several methods for displaying two-dimensional and three-dimensional characteristics of the Earth's surface and atmosphere from information stored in the GIS. Among the methods to store information in the GIS are topological modeling, networks, cartographic modeling and map overlay.

Advantageously, the GIS can recognize and analyze the topological spatial relationships that exist within digitally stored spatial data such as, for example, adjacency (whether a first object adjoins a second object), containment (whether a first object encloses a second object), and proximity (how close a first object is to a second object). The GIS can also simulate the routing of materials along a linear network. Values in a linear network such as, for example, car speed, can represent the flow of traffic. Cartographic modeling refers to a process where several thematic layers of the same area are produced, processed, and analyzed. Cartographic overlays are equivalent to mathematical Venn diagram overlays where a union of overlays combines the geographic features and attributes of both overlays into a single new output. For example, a two-dimensional contour map created from the surface modeling of snowfall measurements can be overlaid and analyzed with a map in the GIS covering the same area, regardless of the characteristics of the map.

Further advantageously, GIS data represents real world objects such as, for example, roads, land use and elevation, with digital data. Real world objects can be divided into two abstractions: 1) discrete objects such as, for example, a hospital or a fire station; and 2) continuous fields such as, for example, elevation or snow fall amount. There are a variety of methods for entering spatial data into the GIS where the data is stored in a digital format. Survey data can be directly entered into the GIS from digital data collection systems on survey instruments. Positions from a Global Positioning System (GPS), aircraft, satellites and remotely sensed data from sensors such as, for example, cameras, digital scanners, and light detection and ranging (LIDAR) devices, can also be directly entered into the GIS. Any object that can be located spatially can be input into the GIS. The GIS can also convert existing digital information, which cannot yet be in map form, into forms that can be recognized and used. The spatial data, after it has been converted, organized, and projected onto the appropriate map by the above methods, can be displayed on a monitor, a web page or on paper so that the user can visualize and understand the results of analyses or simulations.

Disadvantageously, creating digital spatial data is labor intensive and expensive. Non-digital data such as, for example, data printed on paper or polyethylene terephthalate polyester (PET) film maps, must be digitized or scanned to produce digital data that can be entered and stored into a GIS. After the non-digital data is digitized, the data must be transformed into either a relative accuracy coordinate system or an absolute accuracy coordinate system to prevent spatial interpretation errors in the GIS system. Additionally, attribute data for the non-digital data must be entered into the GIS and requires editing to remove errors. For example, in a GIS map representing a road network, lines must connect with nodes at an intersection and blemishes on scanned maps may need to be removed from the digitized image.

Further disadvantageously, current GIS are not user-friendly. First, the GIS plots the specific data inputs and overlays the results onto a static map of a region with symbols to represent physical objects. Then, an analyst reviews the resulting map and performs a manual interpretation of the data. This process is slow and time-consuming, and requires formal training and regular use to effectively use the GIS. For example, topographic maps can show the shape of land surface with contour lines; however, the actual shape of the land can only be imagined by the user. Additionally, data restructuring must be performed by the GIS to convert data that is collected and stored in various incompatible formats into a common format prior to use. There are well over 100 GIS applications on the commercial market with multiple file formats that are not interchangeable. Data developed for a particular GIS software package is stored in a format or structure that is unique to each software package. Conversion from one format to another can result in errors and delays analysis of the information. Also, map information of different scales in the GIS must be manipulated so that the map information of a first map registers or fits with information gathered from a second map. Under some circumstances, before the digital data can be analyzed, it must undergo further manipulations such as, for example, projection conversions and coordinate conversions, prior to integration into the GIS. Further, the current cost of converting non-spatial data into spatial data requires even government agencies to charge a reproduction fee for providing converted data.

Therefore, there exists a need for a geographical information system (GIS) for integrating multiple spatial emergency data, multiple non-spatial emergency data or both multiple spatial emergency data and multiple non-spatial emergency data into a real-time GIS for analyzing emergency data, that is not associated with these disadvantages.

### SUMMARY

According to one embodiment of the present invention, there is provided a method for integrating multiple spatial emergency data, multiple non-spatial emergency data or both multiple spatial emergency data and multiple non-spatial emergency data into a real-time geographic information system for analyzing emergency data. The method comprises a) receiving one or more spatial data set from one or more emergency services vehicle and one or more emergency services provider; b) receiving one or more non-spatial data set from the one or more emergency services vehicle and the one or more emergency services provider; c) converting the one or more spatial data set and the one or more non-spatial data set to a markup language; d) displaying a geographic region on one or more user's console connected to a display; e) overlaying the converted one or more spatial data set and the one or more non-spatial data set on the user selected geographic region on the one or more user's console; f) communicating with the one or more emergency vehicle and the one or more emergency services provider through a communication means connected to the user's console; and g) transmitting one or more trauma activation alert to the one or more emergency vehicle and the one or more emergency services provider through the user's console. In another embodiment, the one or more spatial data set and the one or more non-spatial data set is transmitted by a geographic information system transceiver selected from the group consisting of an automatic vehicle location system transceiver, an integrated global positioning system transceiver, a portable global information system transceiver, an automatic vehicle location system transceiver and an integrated global positioning system transceiver. In another embodiment, the one or more trauma activation alert is selected from the group consisting of estimated arrival time, traffic delays, routing problems, and arrival of the trauma victim to one or more emergency services provider's treatment facility. In another embodiment, the communication means is selected from the group consisting of an internet instant messaging communication system, a radio frequency communications system and a satellite communications system; and each communications means is an overlay displayed on the one or more user's console.

In one embodiment, the method further comprises a) displaying a user selectable regional geographic map on the one or more user's console; b) overlaying a diagram of highway patrol incidents data on the regional geographic map; c) receiving current traffic conditions and overlaying the current traffic conditions on the regional geographic map; d) overlaying one or more emergency services vehicle's location on the regional geographic map; e) overlaying one or more emergency services provider's location on the regional geographic map; f) overlaying current weather conditions on the regional geographic map; g) selectably displaying icons of the one or more emergency services vehicle on the regional geographic map; and h) communicating with the one or more emergency services vehicle. In another embodiment, the current traffic conditions received are selected from the group consisting of real time traffic information camera images, a satellite camera images and one or more emergency services vehicle camera images. In another embodiment, the current traffic conditions overlay displays an average vehicle speed indicator.

In one embodiment, the method further comprises displaying a status of the one or more emergency services vehicle's by placing a mouse cursor over an icon of the one or more emergency services vehicle. The status displayed is selected from the group consisting of fuel status, engagement status, patient vital signs and emergency personnel onboard the one or more emergency services vehicle. In another embodiment, the current weather conditions are displayed on the display and are selected from the group consisting of wind conditions, visibility, weather warnings and cloud conditions. In another embodiment, the icons are animated and the icons change color to indicate a status of the one or more emergency vehicle. In another embodiment, the location of the one or more emergency vehicle is updated in real time.

In one embodiment, the method further comprises overlaying snow depth level data on the regional geographic map. In another embodiment, the snow depth level data is automatically input into the system from the United States National Weather Service Bureau. In another embodiment, the snow depth level data is input into the system if the snow depth is greater than or equal to 12 cm. In another embodiment, the snow depth level data is input into the system, and when the snow depth is greater than or equal to 20 cm then routing the one or more emergency services vehicle around impassable roadways.

In one embodiment, the method further comprises overlaying road accessibility data on the regional geographic map. In another embodiment, terrain contour lines are overlaid on the regional geographic map. In another embodiment, the one or more emergency services provider's status is displayed in the overlay. In another embodiment, the icons of the one or more emergency services vehicle and the one or more emergency services provider change color according to a transmitted report of real time status. In another embodiment, the icons status colors are selected from the group consisting of black, blue, green, red, yellow and white.

In one embodiment, the method further comprises displaying a context sensitive menu of user selectable actions when the user places a cursor over a displayed icon. In one embodiment of the method, clicking on an icon on the one or more user's console displays a menu comprising a) specialty services provided; b) specific care units provided; and c) patient bed availability. In another embodiment, clicking on the icon of the one or more emergency services vehicle activates an interactive communications link between a user and the one or more emergency services vehicle. In another embodiment, only user selected overlays are composited with the regional geographic map and displayed on the one or more user's console; and the composited overlays are scalable. In another embodiment, a preset selection of overlays are composited with the regional geographic map and displayed on the one or more user's console; and the composited overlays are scalable. In another embodiment, placing a mouse cursor over the one or more icon on the composite image produces a list of available resources for object represented by the icon.

In one embodiment, the method further comprises overlaying hazardous materials storage locations on the regional geographic map. In another embodiment, the hazardous materials storage locations are selected from the group consisting of anthrax vaccine, bomb squad locations, cyanide, decontamination units, explosive chemicals and hazardous material units. In another embodiment, overlays are linked together and automatically displayed when a specific emergency vehicle icon is selected by the user. In one embodiment, the method further comprises overlaying a building schematic on the regional geographic map. In another embodiment, the building schematic overlay comprises entry points, exit points, the location of emergency personnel and location of firefighters in the building.

In one embodiment, the method further comprises converting multiple spatial data and multiple non-spatial data into a hypertext markup language overlay and displaying the hypertext markup language overlay. In another embodiment, converting multiple spatial data and multiple non-spatial data comprises a) performing the method; b) inputting data from multiple emergency and non-emergency data sources into a central database; c) determining if the data has changed from a preset state; d) inputting default values into the central database such that a determination that the data has changed in the previous step is always true; e) converting non-spatial data into spatial data; f) converting each quantum of data and associated attributes into one or more hypertext markup language overlays; g) selecting the one or more hypertext markup language overlay to be displayed; h) compositing the one or more hypertext markup language overlay selected with a regional geographic map; and i) displaying the one or more hypertext markup language overlay selected on a display device.

In one embodiment, the method further comprises one or more script for automatically loading overlays that have historically been used in a specific emergency. In another embodiment, the one or more script is selected from the group consisting of an aircraft emergency script, an avalanche script, a building fire script, an earthquake script, an emergency training exercise script, a flood script, a forest fire script, a gas explosion script, a hazardous spill script, a hostage script, a hurricane script, a mass conflagration script, a poison gas script, a riot script, a tornado script, a traffic accident script and a tsunami script.

In one embodiment, the method further comprises overlaying one or more local data set on the regional geographic map. In a preferred embodiment, the one or more local data set is selected from the group consisting of airports, federal government buildings, fire stations, malls, military complexes, police stations, schools, sheriff stations, state government buildings and utility complexes. In another embodiment, the current traffic conditions are selected from the group consisting of traffic incidents, US Cities, Highways, Major Highways, US Metropolitan Statistical Area (MSA) boundaries, Major Inland Water Bodies, Rivers and Streams, Major Parks, Urban Areas, US States, Non-US Land, Oceans names, Seas Names and foreign sovereign states traffic information sources. In another embodiment, the current weather conditions overlaid is selected from the group consisting of US Cities, US States, US Counties, Non-US Land, Oceans and Seas Names, Current Precipitation, precipitation minus 10 minutes, precipitation minus 20 minutes, precipitation minus 30 minutes, precipitation minus 40 minutes, precipitation minus 50 minutes, precipitation minus 60 minutes, US Highways, Satellite Imagery (150 meter scale) and foreign sovereign states precipitation information.

In one embodiment, the method further comprises overlaying real time wildfire position data. In another embodiment, the overlays displayed on the one or more user's console are updated at preset time intervals selected from the group consisting of 1 minute, 2 minute, 5 minute, 10 minute and 15 minute intervals. In another embodiment, the overlays displayed on the one or more user's console are updated at a user selectable time interval between 1 second and 60 minutes. In another embodiment, the overlays displayed on the one or more user's console are updated in real time. In another embodiment, the regional geographic map is selected from the group consisting of a satellite image, a topographical map, a cartographical map and a geographic information system map.

In one embodiment, the method further comprises overlaying a legend for the icons displayed on the one or more user's console. In another embodiment, the legend is color coded. In another embodiment, the legend comprises icons. In another embodiment, the legend comprises icons and color coding. In another embodiment, the legend is displayed in a pop-up dialog box on the one or more user's console when the user places a cursor over a traffic legend icon. In another embodiment, real-time traffic conditions are displayed when a user selects one of the displayed icons. In another embodiment, information is displayed on the one or more user's console when the user places a cursor over the icon of the one or more emergency services vehicle displayed on the one or more user's console, where the information is selected from the group consisting of the one or more emergency services vehicle's unique identification number, a pilot name, an airspeed, a time from a base location, a time to a destination, a personnel status, a patient status and a patient destination. In another embodiment, the communication is transmitted in a manner selected from the group consisting of spoken communication, transmitted text and both spoken communication and transmitted text.

In one embodiment, there is provided a system for integrating multiple spatial emergency data, multiple non-spatial emergency data or both multiple spatial emergency data and multiple non-spatial emergency data into a real-time geographic information system for analyzing emergency data, the system comprising a) one or more emergency services vehicle; b) one or more user's console communicatively coupled to the one or more emergency services vehicle; c) a display electrically connected to the one or more user's console; d) one or more trauma activation alert communicatively coupled to the one or more user's console; and e) a multi-way communications means electrically connected to the one or more user's console. In another embodiment, the one or more emergency services vehicle is equipped with a geographic information system transceiver selected from the group consisting of an automatic vehicle location system, an integrated global positioning system and a portable global information system transceiver where each geographic information system transceiver transmits digital spatial location data. In another embodiment, the one or more trauma activation alert is selected from the group consisting of arrival of the trauma victim, estimated arrival time, routing problems and traffic delays. In another embodiment, the communications system is selected from the group consisting of an internet instant messaging communications system, a radio frequency communications system and a satellite communications system where each communications system is an overlay displayed on the one or more user's console. In another embodiment, the system further comprises a data converter for converting data from non-spatial data into spatial data for use in the system.

In one embodiment, the system further comprises one or more built-in global positioning system transceiver, one or more portable global positioning system transceiver, or both one or more built-in and one or more portable global positioning system transceiver. In another embodiment, the one or more user's console is selected from the group consisting of a computer terminal and a personal computer.

### BRIEF DESCRIPTION OF THE DRAWINGS

These and other features, aspects and advantages of the present invention will become better understood with regard to the following description, appended claims, and accompanying Figures where:

FIG. 1 is an overlay diagram of road condition data to be displayed according to one embodiment of the present invention;

FIG. 2, is an overlay diagram of emergency services helicopter locations to be displayed according to another embodiment of the present invention;

FIG. 3 is an overlay diagram of emergency ground vehicle locations to be displayed according to another embodiment of the present invention;

FIG. 4 is an overlay diagram of snow depth level data to be displayed according to another embodiment of the present invention;

FIG. 5 is an overlay diagram of road accessibility data to be displayed according to another embodiment of the present invention;

FIG. 6 is an overlay diagram of hospital locations to be displayed according to another embodiment of the present invention;

FIG. 7 is a Venn diagram showing multiple overlays placed over each other to be displayed in a GIS according to another embodiment of the present invention;

FIG. 8 is a composite image of the multiple overlays of the spatial data and the non-spatial data of FIG. 7;

FIG. 9 is a flowchart showing some steps of a method for converting multiple spatial and non-spatial data into an overlay diagram to be displayed according to another embodiment of the present invention;

FIG. 10 is a flowchart showing some steps of a method for using an advanced emergency graphical information system for displaying spatial and non-spatial data according to another embodiment of the present invention;

FIG. 11 is a web interface for using advanced emergency graphical information system for displaying spatial and non-spatial data according to another embodiment of the present invention;

FIG. 12 is a web interface for selecting local data displayed on the web interface of FIG. 11;

FIG. 13 is a web interface for selecting current weather conditions displayed on the web interface of FIG. 11;

FIG. 14 is a web interface for selecting traffic information displayed on the web interface of FIG. 11;

FIG. 15 is a web interface for selecting precipitation information displayed on the web interface of FIG. 11;

FIG. 16 is a web interface for reordering the overlays displayed on the web interface of FIG. 11;

FIG. 17 is a web interface for setting the information refresh rate of the web interface of FIG. 11;

FIG. 18 is a screen capture of real-time traffic conditions displayed on the web interface of FIG. 11;

FIG. 19 is a legend of real-time traffic conditions displayed on the web interface of FIG. 11;

FIG. 20 is a screen capture of expanded information display of selected real-time traffic conditions displayed on the web interface of FIG. 11, when the user places a mouse cursor over the displayed icon of FIG. 19;

FIG. 21 is a screen capture of real-time traffic camera information from a user selected point of the displayed icons of FIG. 19;

FIG. 22 is a screen capture of real-time emergency services helicopter information displayed on the web interface of FIG. 11;

FIG. 23 is a screen capture of real-time emergency services helicopter information displayed on the web interface of FIG. 11, 30 seconds after the screen capture of FIG. 22;

FIG. 24 is a screen capture of real-time emergency services helicopter information displayed on the web interface of FIG. 11, 60 seconds after the screen capture of FIG. 22;

FIG. 25 is a screen capture of real-time emergency services helicopter information displayed on the web interface of FIG. 11, 90 seconds after the screen capture of FIG. 22;

FIG. 26 is a screen capture of real-time emergency services helicopter information displayed on the web interface of FIG. 11, 120 seconds after the screen capture of FIG. 22;

FIG. 27 is a screen capture of real-time emergency services helicopter information displayed on the web interface of FIG. 11, 150 seconds after the screen capture of FIG. 22;

FIG. 28 is a screen capture of expanded information of the real-time emergency services helicopter information displayed on the web interface of FIG. 11 when the user places a mouse cursor over the displayed icon of the emergency services helicopter;

FIG. 29 is a screen capture of all available emergency services helicopters in the region displayed on the web interface of FIG. 11;

FIG. 30 is a screen capture of expanded information of a selected emergency services helicopter when the user places a mouse cursor over the icon of the emergency services helicopter displayed on the web interface of FIG. 11;

FIG. 31 is a real-time satellite image overlay displayed on the web interface of FIG. 11;

FIG. 32 is a real-time satellite image overlay, real-time emergency services helicopter information and accident/incident locations displayed on the web interface of FIG. 11;

FIG. 33 is a real-time satellite image overlay, real-time emergency services helicopter information, accident/incident locations and traffic movement indicators displayed on the web interface of FIG. 11.

FIG. 34 is block diagram of a system for integrating multiple spatial emergency data, multiple non-spatial emergency data or both multiple spatial emergency data and multiple non-spatial emergency data into a real-time geographic information system for analyzing emergency data according to one embodiment of the present invention.

### DETAILED DESCRIPTION

According to the present invention, there is provided a method for integrating multiple spatial emergency data, multiple non-spatial emergency data or both multiple spatial emergency data and multiple non-spatial emergency data into a real-time geographic information system for analyzing emergency data.

According to another embodiment of the present invention, there is provided a system for integrating multiple spatial emergency data, multiple non-spatial emergency data or both multiple spatial emergency data and multiple non-spatial emergency data into a real-time geographic information system for analyzing emergency data. The system and method will now be disclosed in detail.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by its intended use.

As used in this disclosure, except where the context requires otherwise, the term “comprise” and variations of the term, such as “comprising”, “comprises” and “comprised” are not intended to exclude other additives, components, integers or steps. The term “emergency services vehicles” refers to any vehicle capable of providing support during an emergency, such as, for example, an ambulance, a helicopter, a fire truck, a police car, a boat, an airplane, etc. The term “emergency services provider” refers to any of the standard facilities that normally respond to an emergency, such as, for example, a hospital, a fire department, a police department, a National Guard division, an urgent care facility, a hazardous waste response unit, etc. The term “web interface” refers to a system of interlinked, hypertext markup language documents accessed via the Internet using a browser, a user views, and navigates between, the hypertext markup language documents that can contain text, images, multimedia and hyperlinks for navigation. The term “spatial data” refers to data or information that identifies the geographic location of features and boundaries on Earth, such as, for example, natural or constructed features, oceans, etc., as coordinates and topology that can be mapped. The term “non-spatial data” refers to data or information that does not contain the attributes of spatial data as defined above.

According to one embodiment of the present invention, there is provided a method for integrating multiple spatial emergency data, multiple non-spatial emergency data or both multiple spatial emergency data and multiple non-spatial emergency data into a real-time geographic information system for analyzing emergency data. Spatial data sets are received from various sources, such as, for example, one or more emergency services vehicle and one or more emergency services provider. Non-spatial data sets can also be received and are converted to spatial data using location information provided by a global positioning system (GPS) transceiver. The spatial and converted non-spatial data is converted to a standard general markup language or a subset thereof to be displayed on a web interface. In one embodiment, a console user selects a map of a geographic region to display in the web interface. In another embodiment, the console user selects one or more spatial data set and one or more non-spatial data set to overlay on the selected regional geographic map. The selected overlays are then composited with the selected regional geographic map and displayed on the web interface. In another embodiment, the composited overlays are scalable. In another embodiment, the console user can communicate with one or more emergency vehicle and one or more emergency services provider through a communication means connected to the user's console. In another embodiment, the console user can transmit one or more trauma activation alert to one or more emergency services vehicle and one or more emergency services provider.

In one embodiment, the method further comprises overlaying diagrams of highway patrol incidents data, current traffic conditions (including an average vehicle speed indicator), current weather conditions, one or more emergency services vehicle's location, and one or more emergency services provider's location on the selected regional geographic map. In another embodiment, the web interface displays icons of the one or more emergency services vehicle on the regional geographic map.

In one embodiment, the status of the one or more emergency services vehicle is displayed on the user's console by placing a cursor over an icon of one or more emergency services vehicle. The status displayed includes fuel status, engagement status, patient vital signs and emergency personnel onboard the one or more emergency services vehicle. In another embodiment, the icons are animated and change color on the web interface to indicate the real-time status of the vehicle or the location selected

In one embodiment, the method further comprises overlaying snow depth level data on the selected regional geographic map. In another embodiment, the snow depth level data is automatically input into the system from the United States National Weather Service Bureau. In another embodiment, the snow depth level data is input into the system if the snow depth is greater than or equal to 12 cm. In another embodiment, the snow depth level data is input into the system, and when the snow depth is greater than or equal to 20 cm. The console user can then activate communications with the emergency services vehicle to route the vehicle around impassable roadways.

In one embodiment, the method further comprises overlaying road accessibility data and terrain contour lines on the selected regional geographic map.

In one embodiment, the method further comprises displaying a context sensitive menu when the user places a cursor over a displayed icon. In one embodiment, clicking on an icon displays a menu of user selectable options or activates an interactive communications link between a user and the one or more emergency service vehicle or the one or more emergency services provider. In another embodiment, a preset selection of overlays is composited with the regional geographic map and displayed on the one or more user's console.

In one embodiment, overlays of hazardous materials storage locations are displayed on the regional geographic map. In another embodiment, overlays are linked together and automatically displayed when a specific emergency vehicle icon is selected by the user. In one embodiment, the method further comprises overlaying a building schematic on the regional geographic map.

In one embodiment, the method further comprises converting multiple spatial data and multiple non-spatial data into a hypertext markup language overlay and displaying the hypertext markup language overlay. In another embodiment, converting multiple spatial data and multiple non-spatial data comprises first performing the method described above. Then inputting data from multiple emergency and non-emergency data sources into a central database. Next, determining if the data has changed from a preset state. Then, inputting default values into the central database such that a determination that the data has changed in the previous step is always true. Next, converting non-spatial data into spatial data. Then, converting each quantum of data and associated attributes into one or more hypertext markup language overlays. Next, selecting the one or more hypertext markup language overlay to be displayed. Then, compositing the one or more hypertext markup language overlay selected with a regional geographic map. Finally, displaying the one or more hypertext markup language overlay selected on a display device. In one embodiment, there is provided one or more script for automatically loading overlays that have historically been used in a specific emergency. In one embodiment, the method further comprises overlaying one or more local data set on the regional geographic map. In one embodiment, real time wildfire position data is overlaid on the selected regional geographic map. In another embodiment, the overlays displayed on the one or more user's console are updated in real time, at a preset time interval or at a user selectable time interval.

In one embodiment, there is provided a system for integrating multiple spatial emergency data, multiple non-spatial emergency data or both multiple spatial emergency data and multiple non-spatial emergency data into a real-time geographic information system for analyzing emergency data, the system comprising a) one or more emergency services vehicle; b) one or more user's console communicatively coupled to the one or more emergency services vehicle; c) a display electrically connected to the one or more user's console; d) one or more trauma activation alert communicatively coupled to the one or more user's console; and e) a multi-way communications means electrically connected to the one or more user's console.

Referring now to FIGS. 1, 2, 3, 4, 5, 6 and 7, there is shown individual overlays that are displayed on one or more user's console.

Referring now to FIG. 1, there is shown an overlay diagram of highway patrol incidents data 100 to be displayed according to one embodiment of the present invention. In a preferred embodiment, current traffic conditions are overlaid onto a regional geographic map.

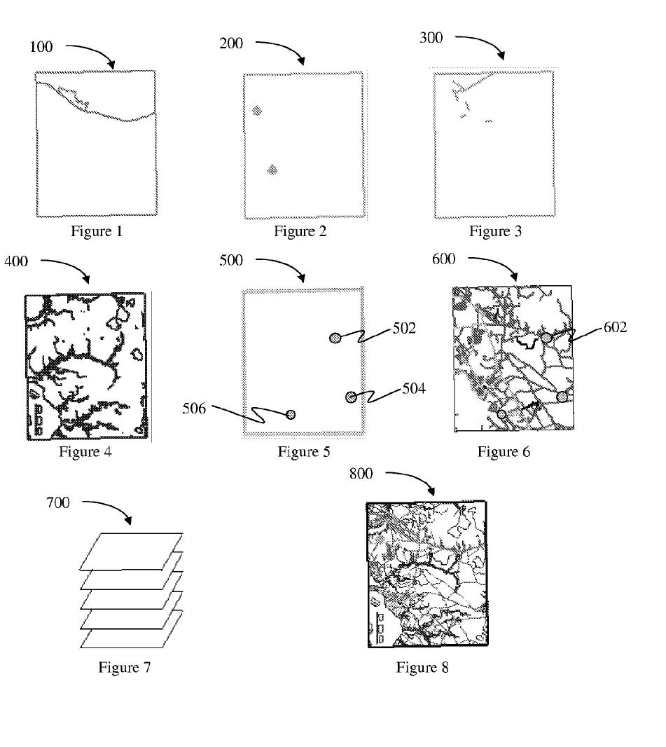

Referring now to FIG. 2, there is shown an overlay of the one or more emergency services vehicle's location 200 according to another embodiment of the present invention, such as, for example, a helicopter. In one embodiment, by placing a mouse cursor over the helicopter icon, the one or more console user's can determine the status of the helicopter such as, for example, a fuel status, an engagement status (i.e., whether the helicopter is currently on an emergency call) or a status of personnel aboard the helicopter such as, for example, a doctor is aboard the helicopter. In another embodiment, current weather conditions such as, for example, wind conditions, visibility, weather warnings, cloud conditions are overlaid on a regional geographic map. In another embodiment, the icons are animated such as, for example, the helicopter icon propellers rotate to indicate the helicopter is moving.

Referring now to FIG. 3, there is shown an overlay diagram of one or more emergency services vehicle locations 300, such as, for example, ground based emergency vehicles, according to another embodiment of the present invention. In one embodiment, the one or more emergency services vehicle is equipped with an automatic vehicle location system with an integrated global positioning system (GPS) that feeds digital spatial location data into the system. In one embodiment, the one or more emergency services vehicle is displayed as an icon. In another embodiment, the one or more emergency services vehicle icon changes color depending upon the status of the one or more emergency services vehicle to allow for easy and quick interpretation by a user.

Referring now to FIG. 4, there is shown an overlay diagram of snow depth level data 400 according to another embodiment of the present invention. In one embodiment, the snow depth level data 400 is automatically input into the system from the United States National Weather Service Bureau. In another embodiment, the snow depth level data 400 is input into the system if the snow depth is greater than or equal to 12 cm. In another embodiment, the snow depth level data 400 is input into the system, and when the snow depth is greater than or equal to 20 cm then routing the one or more emergency services vehicle around impassable roadways.

Referring now to FIG. 5, there is shown an overlay diagram of one or more hospital location 500 according to another embodiment of the present invention. In one embodiment, the one or more hospital location are icons 502, 504, 506. In another embodiment, the icons 502, 504, 506 will change color according to the hospital's real time reported status. For example, the icon 502 of a hospital that is on internal disaster will change color to red indicating that no ambulances can be sent to that hospital. In another embodiment, when the console user places a cursor over, and clicks on a displayed hospital icon 504, the user console displays a context sensitive menu of options available for that specific icon such as, for example, left clicking on a hospital icon can display a menu comprising: 1) specialty services provided by a hospital such as, for example, a cardiovascular surgeon, a neurosurgeon, and an orthopedic surgeon; 2) specific care units at the hospital such as, for example, a trauma center or a neonatal care unit; and 3) patient bed availability at the hospital. In another embodiment, the one or more console user can communicate interactively with the one or more emergency services vehicle by placing a cursor over the icon of the one or more emergency services vehicle and clicking on the icon to open a communication means. In another embodiment, the communication is transmitted in a manner selected from the group consisting of spoken communication, transmitted text and both spoken communication and transmitted text.

Referring now to FIG. 6, there is shown an overlay diagram of road accessibility data 600 according to another embodiment of the present invention. In one embodiment, terrain contour lines are overlaid on a map of a displayed region to provide quick analysis of the types of vehicles that can be sent into the region displayed. For example, in one embodiment, if an accident occurs on a mountain road a dispatcher dispatches an all-terrain ambulance rather than a standard ambulance.

Referring now to FIG. 7, there is shown a Venn diagram showing multiple overlays that are placed over each other to be composited with a regional geographic map according to another embodiment of the present invention. In one embodiment, only user selected overlays are composited. In another embodiment, a preset selection of overlays is composited. For example, if a patient being transported has a heart condition, personnel in the one or more emergency services vehicle or the console user can route the one or more emergency services vehicle to the nearest emergency services provider's facility with a cardiac care center.

Further, the present system supports efficient use of personnel. For example, a trauma activation in an Emergency Department (“ED”) alerts 10-20 people in the trauma unit including trauma surgeons, ED physicians and nurses who must wait until a trauma victim arrives. The waiting can be in excess of 15 minutes which could be used by those 10-20 people to treat other patients. The present invention addresses this problem by alerting ED personnel to an estimated arrival time, traffic delays, routing problems, and by providing timely notification of the arrival of the trauma victim to the ED, thereby maximizing personnel resources.

Referring now to FIG. 8, there is shown a composited image of multiple user selected overlays of the spatial data and the non-spatial data of FIG. 7. In one embodiment, the composited image is scalable. In another embodiment, placing a cursor over icons on the composited image will list the resources available for the object represented by the icon such as, for example, hospital specialty units, specialists on call, ambulance status and helicopter positions. In another embodiment, there is provided an overlay of hazardous materials resources such as, for example, explosive chemicals or cyanide, anthrax vaccine, bomb squad locations, decontamination units and hazardous material units that are overlaid onto a regional geographic map. In another embodiment, the overlays are linked together and additional overlays are automatically added if a specific type of emergency vehicle is selected such as, for example, if the console user selects an emergency services helicopter overlay, then a weather overlay is automatically added and composited with the emergency services helicopter overlay because wind and weather conditions affect the emergency services helicopters operation. In one embodiment, a building schematic overlay comprising entry points, exit points, location of firefighters in the building and the location of emergency personnel are displayed on the console user's display when the building schematic is selected.

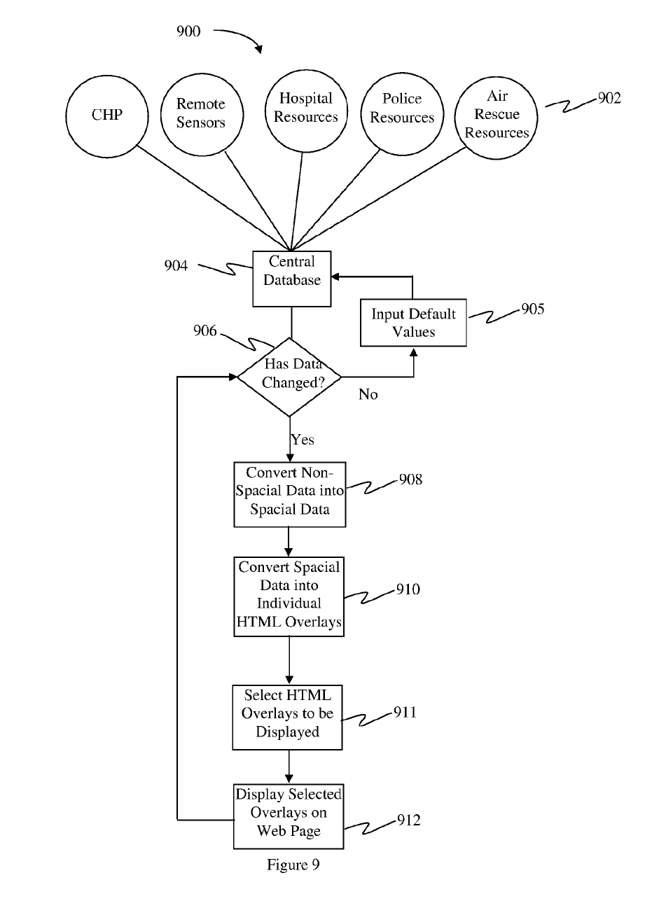

Referring now to FIG. 9, there is shown a flowchart 900 showing some steps of a method according to another embodiment of the present invention. First, multiple emergency and non-emergency data 902 is input into a central database 904. Then, a determination is made if the data has changed 906. In another embodiment, default values 905 are input into the central database 904 such that the determination that the data is changed 906 in the previous step is always true. Next, non-spatial data, if present, is converted 908 into spatial data. Then, each quantum of data and associated attributes, are converted into separate hypertext markup language (HTML) overlays 910. Next, the selected overlays 911 are composited with a regional geographic map and displayed 912 on a display device. In a preferred embodiment, the overlays are selectable.

In one embodiment, the method further comprises one or more script for automatically loading overlays that have historically been used in a specific emergency such as, for example, an earthquake script will automatically retrieve and display the overlays for the most common emergency resources utilized in previous earthquakes. In another embodiment, additional scripts can be added by a console user. In another embodiment, the one or more script is selected from the group consisting of an aircraft emergency script, an avalanche script, a building fire script, an earthquake script, an emergency training exercise script, a flood script, a forest fire script, a gas explosion script, a hazardous spill script, a hostage script, a hurricane script, a mass conflagration script, a poison gas script, a riot script, a tornado script, a traffic accident script and a tsunami script.

In one embodiment, there is provided an instant messaging function for communicating with the one or more emergency services vehicle and the one or more emergency services provider.

In a preferred embodiment, the non-spatial data such as, for example, the Rapid Emergency Digital Data Information Network (Reddinet) system is converted into spatial data. The Reddinet system connects all hospitals, agencies, and service providers within regional healthcare systems, and displays real time, regional and inter-regional diversion data and available care facility resources.

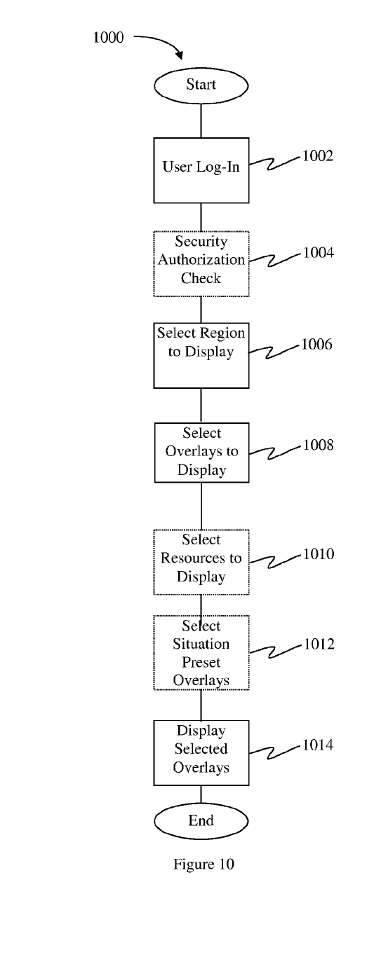

Referring now to FIG. 10, there is shown a flowchart 1000 showing some steps of a method according to another embodiment of the present invention. First, the console user enters a user name and a user password to access the system 1002. Optionally, in another embodiment, a security check is performed 1004 to verify that the console user is authorized to select and view the selected data. Then, the console user selects a region to display 1006 using a satellite image of the Earth. The console user can enlarge the relevant region as needed. Next, the user selects the overlays to display 1008. Optionally, in another embodiment, the user can select one or more local data set, one or more emergency services vehicle and one or more emergency services provider such as, for example, hospitals, schools, police stations and fire stations, and the appropriate overlay is displayed. Optionally, in another embodiment, the user can select a set of overlays for a preset situation 1012 such as, for example, an earthquake, a mass traffic accident or a wild fire. Then, the selected overlays are displayed on the user's console. In a preferred embodiment, personnel in the field or at the emergency site are equipped with satellite communication internet access devices for evaluating an emergency situation that would be unknown to field personnel not using the present invention. Such as, for example, whether, due to inclement weather conditions, to call an emergency services helicopter or one or more emergency services vehicle to drive directly to a hospital. In one embodiment, emergency services vehicles that are not already part of the system such as, for example, out of state fire personnel, can be added to the system by dispensing GPS enabled equipment that is part of the system such as, for example, a cell phone with GPS tracking enabled. Thereby, providing tracking and effective utilization of one or more emergency services vehicle that are foreign to the system. In a particularly preferred embodiment, the GIS information for each of the one or more emergency services vehicle and one or more emergency services providers is updated in real time.

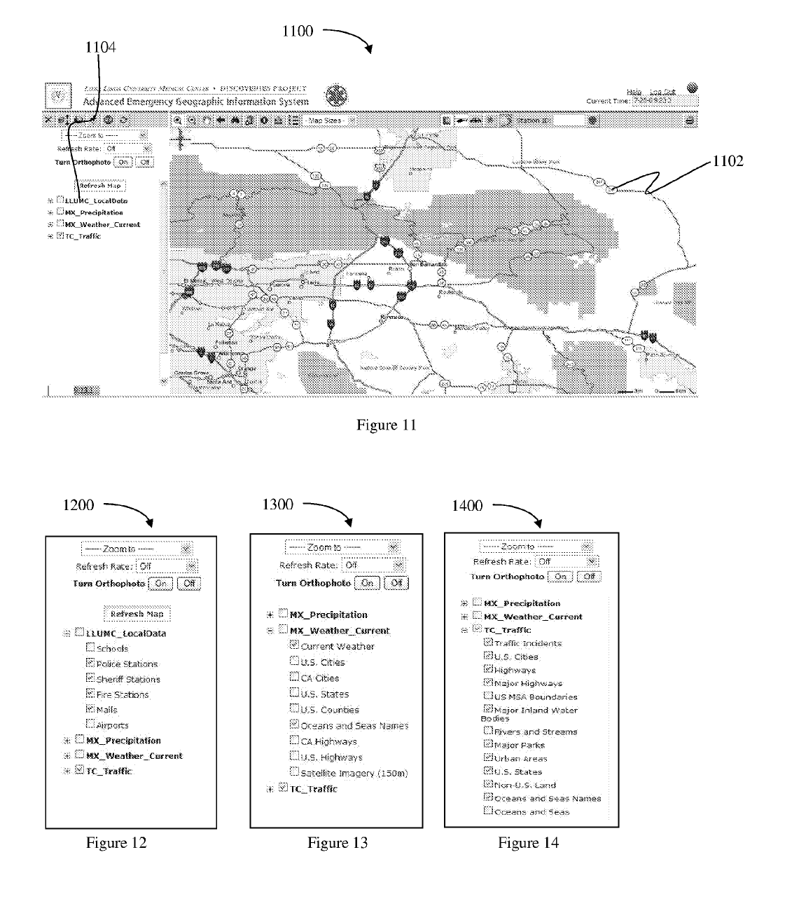

Referring now to FIG. 11, there is shown a web interface 1100 for performing the method. In one embodiment, a user selected regional geographic map 1102 is displayed in a right portion of the web interface and selectable overlays 1104 are displayed in a left portion of the web interface. In another embodiment, the web interface is user configurable to display the user selected region and the user selectable overlays at any position on the user's console.

Referring now to FIG. 12, there is shown a web interface for selecting one or more local data set 1200 to be displayed on the user's console in the web interface of FIG. 11. In one embodiment, the one or more local data set is selected from the group consisting of airports, federal government buildings, fire stations, malls, military complexes, police stations, schools, sheriff stations, state government buildings and utility complexes.

Referring now to FIG. 13, there is shown a web interface for selecting current weather conditions 1300 to be displayed on the user's console in the web interface of FIG. 11. In one embodiment, current weather conditions overlaid is selected from the group consisting of US Cities, US States, US Counties, Non-US Land, Oceans and Seas Names, Current Precipitation, precipitation minus 10 minutes, precipitation minus 20 minutes, precipitation minus 30 minutes, precipitation minus 40 minutes, precipitation minus 50 minutes, precipitation minus 60 minutes, US Highways, satellite imagery (150 meter scale) and foreign sovereign states precipitation information.

Referring now to FIG. 14, there is shown a web interface for selecting traffic information overlay 1400 to be composited in the web interface of FIG. 11. In one embodiment, the web interface for selecting traffic information comprises traffic incidents, US cities, highways, major highways, US Metropolitan Statistical Area (MSA) boundaries, major inland water bodies, rivers and streams, major parks, urban areas, US States, non-US land, oceans and seas names, oceans and seas. In another embodiment (not shown), the web interface for selecting traffic information comprises traffic information from foreign sovereign state's traffic information sources.

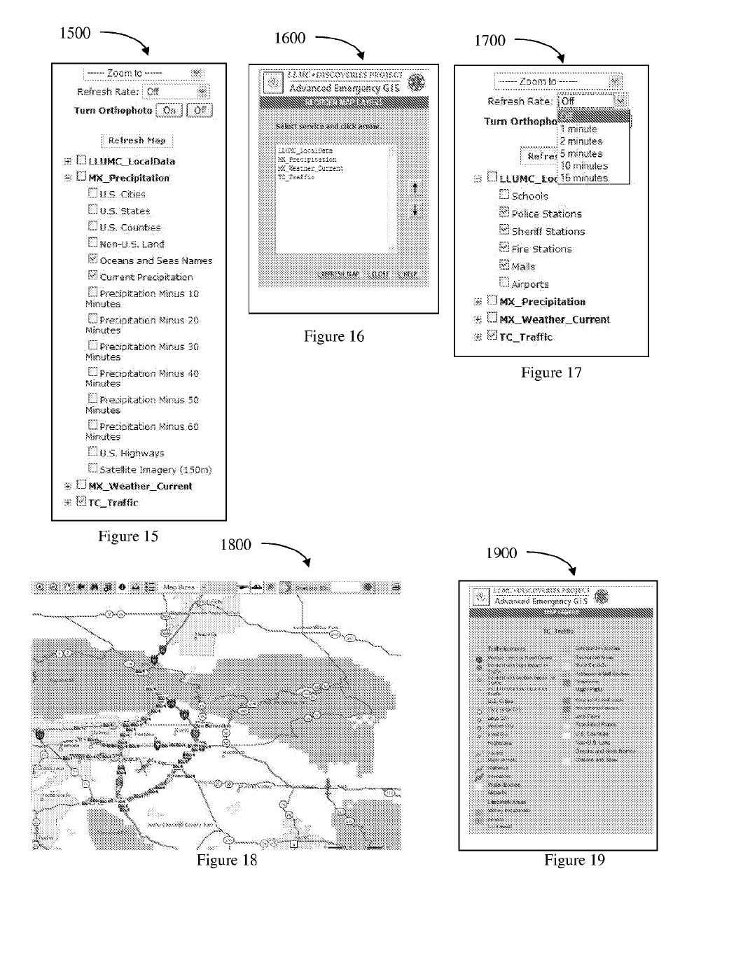

Referring now to FIG. 15, there is shown a web interface for selecting precipitation information 1500 displayed on the web interface of FIG. 11 according to one embodiment of the present invention. In one embodiment, the web interface for selecting precipitation information comprises US Cities, US States, US Counties, non-US land, oceans and seas names, current precipitation, precipitation minus 10 minutes, precipitation minus 20 minutes, precipitation minus 30 minutes, precipitation minus 40 minutes, precipitation minus 50 minutes, precipitation minus 60 minutes, US Highways, Satellite Imagery (150 m). In another embodiment (not shown), the web interface for selecting precipitation information comprises information available for display from foreign sovereign states precipitation information sources.

Referring now to FIG. 16, there is shown a web interface for reordering the overlays 1600 displayed on the web interface of FIG. 11. In one embodiment, the web interface for reordering the overlays comprises a local data overlay, a precipitation overlay, a current weather overlay and a traffic overlay. In another embodiment (not shown), the web interface for reordering the overlays comprises other information sources incorporated into the system such as, for example, a wildfire position overlay.

Referring now to FIG. 17, there is shown a web interface for setting the information refresh rate 1700 of the web interface of FIG. 11. In one embodiment, the web interface for setting the information refresh rate 1700 comprises 1 minute, 2 minute, 5 minute, 10 minute and 15 minute time intervals. In another embodiment (not shown), the web interface for setting the information refresh rate 1700 comprises a user selectable time interval between 1 second and 60 minutes.

Referring now to FIG. 18, there is shown a screen capture of real-time traffic conditions overlay 1800 displayed on the web interface of FIG. 11. In one embodiment, the real-time traffic conditions overlay 1800 comprises data from state, county and local traffic information sources. The real-time traffic conditions overlay 1800 is composited with a console user's selected regional geographic map. In one embodiment, the regional geographic map is selected from the group consisting of a satellite image, a topographical map, a cartographical map and a geographic information system map.

Referring now to FIG. 19, there is shown a legend 1900 of real-time traffic conditions 1800 displayed on the web interface of FIG. 11. In one embodiment, the legend 1900 is color coded. In another embodiment, the legend 1900 comprises icons. In a preferred embodiment, the legend 1900 comprises both color coding and icons.

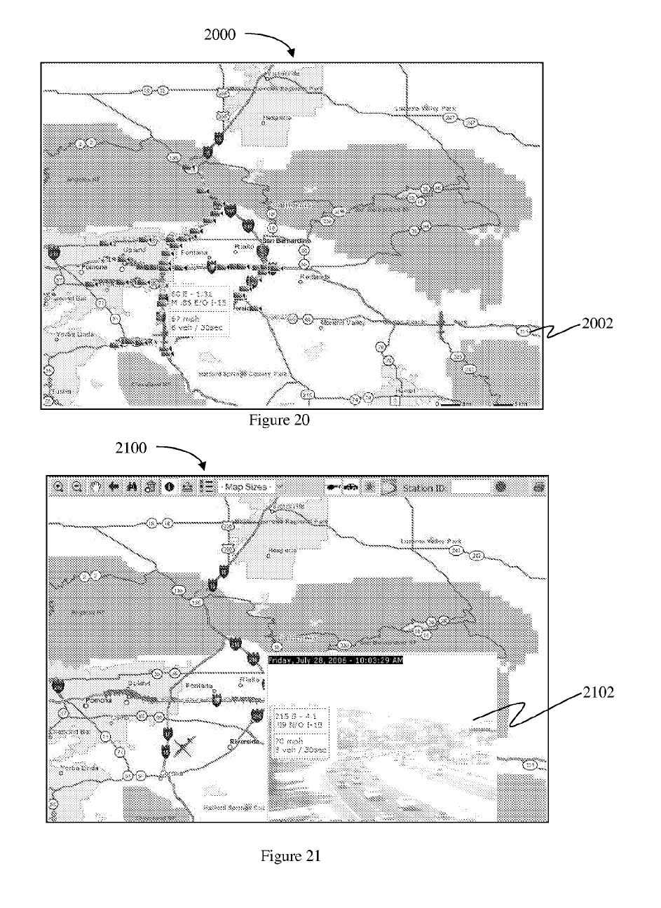

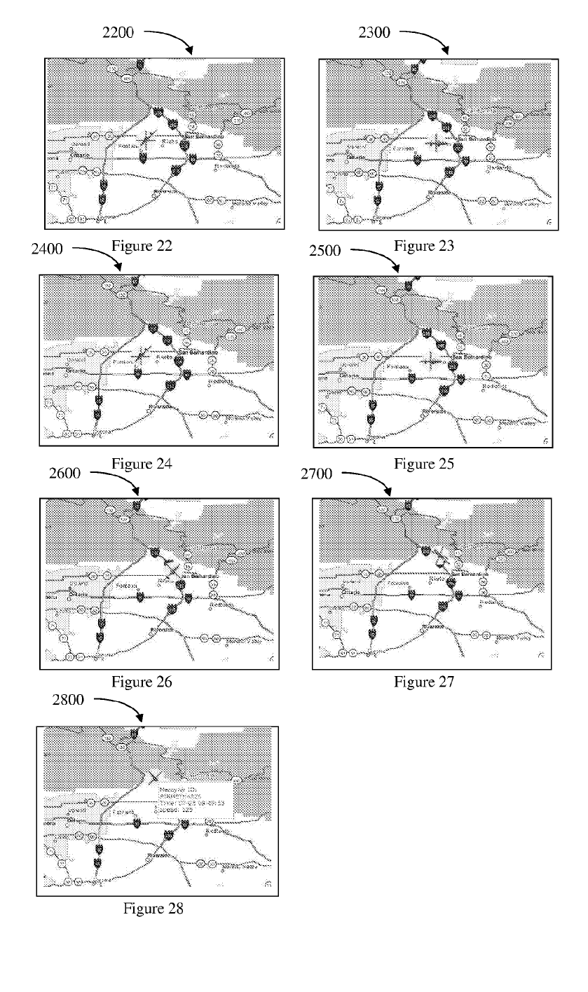

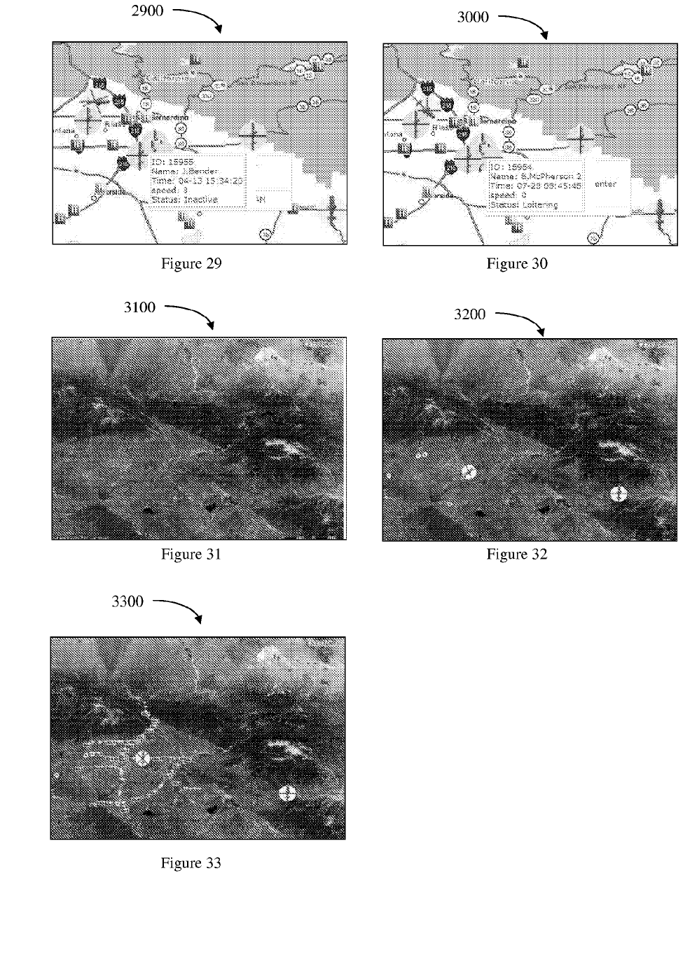

Referring now to FIG. 20, there is shown a screen capture of an up scaled composited overlay 2000 of real-time traffic conditions 1800 displayed on the web interface of FIG. 11, when the console user places a cursor over the icon of FIG. 19. In one embodiment, the console user can place a cursor over a traffic legend icon 2002 and information related to the traffic legend icon 2002 is displayed in a pop-up dialog box (not shown). In another embodiment, the current traffic conditions overlay displays an average vehicle speed indicator is overlaid onto the regional geographic map.

Referring now to FIG. 21, there is shown a screen capture of real-time traffic camera information 2100 from a user selected point of the displayed icons of FIG. 19. In one embodiment, the console user can view real-time traffic conditions from one or more traffic camera video sources. In another embodiment, the current traffic conditions video sources received are selected from the group consisting of real time traffic information camera images, one or more satellite camera images and one or more emergency services vehicle camera images. In another embodiment, live traffic camera images feed are displayed in only a portion of the one or more user's console and will cover a portion of the regional geographic map.

Referring now to FIGS. 22, 23, 24, 25, 26 and 27, there is shown screen captures of real-time emergency services vehicle's information, such as, for example, a helicopter, is displayed on the web interface of FIG. 11 at 30, 60, 90, 120 and 150 seconds, respectively, after the initial screen capture of FIG. 22. In one embodiment, an icon of the emergency services vehicle is overlaid on the web map and displayed on the one or more user's console. The emergency services vehicle's position is updated in real time to the central database using global positioning system (GPS) equipment aboard each emergency services vehicle.

Referring now to FIG. 28, there is shown a screen capture of expanded information 2800 of the real-time helicopter information displayed on the web interface of FIG. 11 when the user places a mouse cursor over the displayed icon of the emergency services helicopter. In one embodiment, the emergency services helicopter's unique identification, airspeed and time are displayed when the user places the mouse cursor over the emergency services helicopter icon. In another embodiment, additional information is displayed when the user places the mouse cursor over the emergency services helicopter icon such as, for example, personnel status (i.e., number and type of personnel aboard), patient status, destination (i.e., going to, or coming from an emergency call). In another embodiment, clicking on the emergency services helicopter icon can open a communications program to allow the user to communicate with the helicopter. In another embodiment, the communication is text. In another embodiment, the communication is verbal. In another embodiment, the communication is both text and verbal.

Referring now to FIG. 29 and FIG. 30, there is shown a screen capture of all available emergency services helicopters in the region displayed on the web interface of FIG. 11. In one embodiment, placing a mouse cursor over an icon of an available emergency services helicopter displays the status of the emergency services helicopter and the name of the pilot such as, for example, emergency services helicopter 15955 in FIG. 29 is inactive and the pilot's name is J. Bender and emergency services helicopter 15954 in FIG. 30 is loitering and the pilot's name is B. McPherson.

Referring now to FIGS. 31, 32 and 33, there is shown a real-time satellite image overlay displayed on the web interface of FIG. 11. In one embodiment, the real-time satellite image comprises no overlays for the user view the user selected region without any additional information displayed shown in FIG. 31. In another embodiment, a single user select overlay is displayed atop the user selected region as shown in FIG. 32. In a preferred embodiment, multiple overlays are displayed on the user selected region as shown in FIG. 33. In a particularly preferred embodiment (not shown), the satellite image of the user selected region is an overlay that is user can select to be displayed.

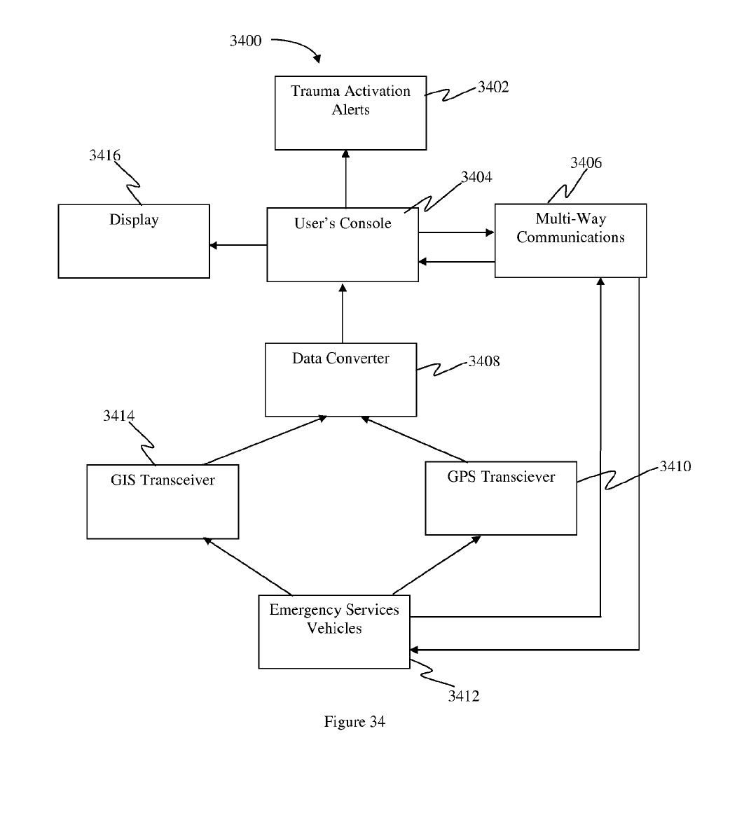

Referring now to FIG. 34, there is shown a diagram of a system 3400 for integrating multiple spatial emergency data, multiple non-spatial emergency data or both multiple spatial emergency data and multiple non-spatial emergency data into a real-time geographic information system for analyzing emergency data. In one embodiment, the system comprises one or more emergency services vehicle 3412, one or more user's console 3404 communicatively coupled to the one or more emergency services vehicle, a display 3416, one or more trauma activation alerts 3402, one or more multi-way communications means 3406, one or more geographic information system (“GIS”) transceivers 3414 selected from the group consisting of an automatic vehicle location system (not shown), an integrated global positioning system 3410 and a portable global information system transceiver (not shown). In another embodiment, each geographic information system transceiver 3414 transmits digital spatial location data. In another embodiment, the one or more trauma activation alerts 3402 is selected from the group consisting of arrival of the trauma victim, estimated arrival time, routing problems and traffic delays. In another embodiment, the multi-way communications means 3406 is selected from the group consisting of an internet instant messaging communications system, a radio frequency communications system and a satellite communications system. In another embodiment, each communications means 3406 is an overlay displayed on the one or more user's console 3404. In one embodiment, the data converter 3408 converts non-spatial data into spatial data for use in the system 3400. In another embodiment, the one or more user's console 3404 is selected from the group consisting of a computer terminal and a personal computer.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A method for integrating multiple spatial emergency data, multiple non-spatial emergency data or both multiple spatial emergency data and multiple non-spatial emergency data into a real-time geographic information system for analyzing emergency data, the method comprising:
a) receiving one or more spatial data sets from one or more emergency services vehicle and one or more emergency services providers;
b) receiving one or more non-spatial data sets from the one or more emergency services vehicle and the one or more emergency services providers;
c) converting the one or more spatial data sets and the one or more non-spatial data sets to a markup language;
d) displaying a regional geographic map on one or more user's console connected to a display;
e) overlaying the converted one or more spatial data sets and the one or more non-spatial data sets on the user selected regional geographic map on the one or more user's console;
f) communicating with the one or more emergency vehicle and the one or more emergency services providers through a communication means connected to the one or more user's console; and
g) transmitting one or more trauma activation alerts to the one or more emergency vehicles and the one or more emergency services providers through the one or more user's console.

2. The method of claim 1, where the one or more spatial data sets and the one or more non-spatial data sets is transmitted by a geographic information system transceiver selected from the group consisting of an automatic vehicle location system transceiver, an integrated global positioning system transceiver, a portable global information system transceiver, an automatic vehicle location system transceiver and an integrated global positioning system transceiver.

3. The method of claim 1, where the one or more trauma activation alerts is selected from the group consisting of estimated arrival time, traffic delays, routing problems, and arrival of the trauma victim to one or more emergency services provider's treatment facility.

4. The method of claim 1, where the communication means is selected from the group consisting of an internet instant messaging communication system, a radio frequency communications system and a satellite communications system; and
where each communications means is an overlay displayed on the one or more user's console.

5. The method of claim 1, further comprising:
a) displaying a user selectable regional geographic map on the one or more user's console;
b) overlaying a diagram of highway patrol incidents data on the regional geographic map;
c) receiving current traffic conditions and overlaying the current traffic conditions on the regional geographic map;
d) overlaying one or more emergency services vehicle's location on the regional geographic map;
e) overlaying one or more emergency services provider's location on the regional geographic map;
f) overlaying current weather conditions on the regional geographic map;
g) selectably displaying icons of the one or more emergency services vehicle on the regional geographic map; and
h) communicating with the one or more emergency services vehicle.

6. The method of claim 5, where the current traffic conditions received are selected from the group consisting of real time traffic information camera images, a satellite camera images and one or more emergency services vehicle camera images.

7. The method of claim 5, where the current traffic conditions overlay displays an average vehicle speed indicator.

8. The method of claim 5, further comprising displaying a status of the one or more emergency services vehicle's by placing a mouse cursor over an icon of the one or more emergency services vehicle.

9. The status according to claim 8, where the status displayed is selected from the group consisting of fuel status, engagement status, patient vital signs and emergency personnel onboard the one or more emergency services vehicle.

10. The method of claim 5, where the current weather conditions are displayed on the display and are selected from the group consisting of wind conditions, visibility, weather warnings and cloud conditions.

11. The method of claim 5, where the icons are animated.

12. The method of claim 5, where the location of the one or more emergency vehicles is updated in real time.

13. The method of claim 5, where the icons change color to indicate a status of the one or more emergency vehicles.

14. The method of claim 5, further comprising overlaying snow depth level data on the regional geographic map.

15. The method of claim 14, where the snow depth level data is automatically input into the system from the United States National Weather Service Bureau.

16. The method of claim 14, where the snow depth level data is input into the system if the snow depth is greater than or equal to 12 cm.

17. The method of claim 14, where the snow depth level data is input into the system, and when the snow depth is greater than or equal to 20 cm then routing the one or more emergency services vehicle around impassable roadways.

18. The method of claim 5, further comprising overlaying road accessibility data on the regional geographic map.

19. The method of claim 18, where terrain contour lines are overlaid on the regional geographic map.

20. The method of claim 5, where the one or more emergency services provider's status is displayed in the overlay.

21. The method of claim 5, where the icons of the one or more emergency services vehicle and the one or more emergency services providers change color according to a transmitted report of real time status.

22. The method of claim 21, where the icons status colors are selected from the group consisting of black, blue, green, red, yellow and white.

23. The method of claim 5, further comprising displaying a context sensitive menu of user selectable actions when the user places a cursor over a displayed icon.

24. The method of claim 5, where clicking on an icon on the one or more user's console displays a menu comprising:
a) specialty services provided;
b) specific care units provided; and
c) patient bed availability.

25. The method of claim 5, where clicking on the icon of the one or more emergency services vehicle activates an interactive communications link between a user and the one or more emergency services vehicle.

26. The method of claim 5, where only user selected overlays are composited with the regional geographic map and displayed on the one or more user's console; and
where the composited overlays are scalable.

27. The method of claim 5, where a preset selection of overlays are composited with the regional geographic map and displayed on the one or more user's console; and
where the composited overlays are scalable.

28. The method of claim 5, where placing a mouse cursor over the one or more icons on the composite image produces a list of available resources for object represented by the icon.

29. The method of claim 5, further comprising overlaying hazardous materials storage locations on the regional geographic map.

30. The method of claim 29, where the hazardous materials storage locations are selected from the group consisting of anthrax vaccine, bomb squad locations, cyanide, decontamination units, explosive chemicals and hazardous material units.

31. The method of claim 5, where overlays are linked together and automatically displayed when a specific emergency vehicle icon is selected by the user.

32. The method of claim 5, further comprising overlaying a building schematic on the regional geographic map.

33. The method of claim 32, where the building schematic overlay comprises entry points, exit points, the location of emergency personnel and location of firefighters in the building.

34. The method of claim 5, further comprising converting multiple spatial data and multiple non-spatial data into a hypertext markup language overlay and displaying the hypertext markup language overlay.

35. The method of claim 34 for converting multiple spatial data and multiple non-spatial data, the method comprising:
a) performing the method of claim 5;
b) inputting data from multiple emergency and non-emergency data sources into a central database;
c) determining if the data has changed from a preset state;
d) inputting default values into the central database such that a determination that the data has changed in the previous step is always true;
e) converting non-spatial data into spatial data;
f) converting each quantum of data and associated attributes into one or more hypertext markup language overlays;
g) selecting the one or more hypertext markup language overlays to be displayed;
h) compositing the one or more hypertext markup language overlays selected with a regional geographic map; and
i) displaying the one or more hypertext markup language overlays selected on a display device.

36. The method of claim 5, further comprising one or more scripts for automatically loading overlays that have historically been used in a specific emergency.

37. The method of claim 36, where the one or more scripts is selected from the group consisting of an aircraft emergency script, an avalanche script, a building fire script, an earthquake script, an emergency training exercise script, a flood script, a forest fire script, a gas explosion script, a hazardous spill script, a hostage script, a hurricane script, a mass conflagration script, a poison gas script, a riot script, a tornado script, a traffic accident script and a tsunami script.

38. The method of claim 5, further comprising overlaying one or more local data set on the regional geographic map.

39. The method of claim 38, where the one or more local data set is selected from the group consisting of airports, federal government buildings, fire stations, malls, military complexes, police stations, schools, sheriff stations, state government buildings and utility complexes.

40. The method of claim 5, where the current traffic conditions are selected from the group consisting of traffic incidents, US Cities, Highways, Major Highways, US Metropolitan Statistical Area (MSA) boundaries, Major Inland Water Bodies, Rivers and Streams, Major Parks, Urban Areas, US States, Non-US Land, Oceans names, Seas Names and foreign sovereign states traffic information sources.

41. The method of claim 5, where the current weather conditions overlaid is selected from the group consisting of US Cities, US States, US Counties, Non-US Land, Oceans and Seas Names, Current Precipitation, precipitation minus 10 minutes, precipitation minus 20 minutes, precipitation minus 30 minutes, precipitation minus 40 minutes, precipitation minus 50 minutes, precipitation minus 60 minutes, US Highways, Satellite Imagery (150 meter scale) and foreign sovereign states precipitation information.

42. The method of claim 5, further comprising overlaying real time wildfire position data.

43. The method of claim 5, where the overlays displayed on the one or more user's console are updated at preset time intervals selected from the group consisting of 1 minute, 2 minute, 5 minute, 10 minute and 15 minute intervals.

44. The method of claim 5, where the overlays displayed on the one or more user's console are updated at a user selectable time interval between 1 second and 60 minutes.

45. The method of claim 5, where the overlays displayed on the one or more user's console are updated in real time.

46. The method of claim 5, where the regional geographic map is selected from the group consisting of a satellite image, a topographical map, a cartographical map and a geographic information system map.

47. The method of claim 5, further comprising overlaying a legend for the icons displayed on the one or more user's console.

48. The method of claim 47, where the legend is color coded.

49. The method of claim 47, where the legend comprises icons.

50. The method of claim 47, where the legend comprises icons and color coding.

51. The method of claim 47, where the legend is displayed in a pop-up dialog box on the one or more user's console when the user places a cursor over a traffic legend icon.

52. The method of claim 5, where real-time traffic conditions are displayed when a user selects one of the displayed icons.

53. The method of claim 5, where information is displayed on the one or more user's console when the user places a cursor over the icon of the one or more emergency services vehicle displayed on the one or more user's console; and
where the information is selected from the group consisting of the one or more emergency services vehicle's unique identification number, a pilot name, an airspeed, a time from a base location, a time to a destination, a personnel status, a patient status and a patient destination.

54. The method of claim 5, where the communication is transmitted in a manner selected from the group consisting of spoken communication, transmitted text and both spoken communication and transmitted text.

55. A system for integrating multiple spatial emergency data, multiple non-spatial emergency data or both multiple spatial emergency data and multiple non-spatial emergency data into a real-time geographic information system for analyzing emergency data, the system comprising:
a) one or more emergency services vehicle;
b) one or more user's console communicatively coupled to the one or more emergency services vehicle;
c) a display electrically connected to the one or more user's console;
d) one or more trauma activation alerts communicatively coupled to the one or more user's console; and
e) a multi-way communications means electrically connected to the one or more user's console.

56. The system of claim 55, where the one or more emergency services vehicle is equipped with a geographic information system transceiver selected from the group consisting of an automatic vehicle location system, an integrated global positioning system and a portable global information system transceiver; and
where each geographic information system transceiver transmits digital spatial location data.

57. The system of claim 55, where the one or more trauma activation alerts is selected from the group consisting of arrival of the trauma victim, estimated arrival time, routing problems and traffic delays.

58. The system of claim 55, where the multi-way communications means is selected from the group consisting of an internet instant messaging communications system, a radio frequency communications system and a satellite communications system; and
where each multi-way communications means is an overlay displayed on the one or more user's console.

59. The system of claim 55, further comprising a data converter for converting data from non-spatial data into spatial data for use in the system.

60. The system of claim 55, further comprising one or more built-in global positioning system transceivers, one or more portable global positioning system transceivers, or both one or more built-in and one or more portable global positioning system transceivers.

61. The system of claim 55, where the one or more user's console is selected from the group consisting of a computer terminal and a personal computer.
